(19) United States
(12) Patent Application Publication
(10) Pub. No.: US 2025/0383625 A1
(43) Pub. Date: Dec. 18, 2025

(54) SYSTEMS AND METHODS FOR MITIGATING VEHICLE OPERATOR FATIGUE USING A HOLOGRAPHIC AGENT

(71) Applicant: HONEYWELL INTERNATIONAL INC., Charlotte, NC (US)

(72) Inventors: Tor Finseth, Plymouth, MN (US); Robert De Mers, Plymouth, MN (US); Nichola Lubold, Phoenix, AZ (US)

(73) Assignee: HONEYWELL INTERNATIONAL INC., Charlotte, NC (US)

(21) Appl. No.: 18/746,976

(22) Filed: Jun. 18, 2024

(51) Int. Cl. G03H 1/00; G06V 20/59; G06V 40/10

(52) U.S. Cl. CPC G03H 1/0005; G06V 20/59; G06V 40/10

(57) ABSTRACT

Systems and methods are provided for mitigating vehicle operator fatigue using a holographic agent. Operator alertness data associated with a vehicle operator is received from an operator monitoring system. A first agent action is generated based at least in part on the operator alertness data. A first command is transmitted to a hologram generation system to generate a holographic agent to implement the first agent action. Updated operator alertness data is received from the operator monitoring system following implementation of the first agent action by the holographic agent. A second agent action is generated based at least in part on the updated operator alertness data. A second command is transmitted to the hologram generation system to generate the holographic agent to implement the second agent action.

### TECHNICAL FIELD

The present invention generally relates to aircraft operations and more particularly relates to systems and methods for mitigating vehicle operator fatigue using a holographic agent.

### BACKGROUND

On two-person flightdecks, pilots typically maintain their alertness through a rich stream of gestures, expressions, and vocalizations between themselves. This is an effective mechanism for maintaining alertness because humans are physiologically predisposed to find the company of other people compelling. In many instances, other forms of stimulation, such as for example, music, message alerts, and secondary tasks are often ineffective at maintaining pilot alertness as they may provide temporary stimulation effects or may be perceived as an annoying form of stimulation. In the future, some types of aircraft, such as for example, air taxis and other intermediate forms of urban air mobility (UAM) aircraft, may rely on single pilot operations.

Hence, there is a need for systems and methods for mitigating vehicle operator fatigue using a holographic agent to provide the same type of simulation as a physical person.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various embodiments, a system for mitigating vehicle operator fatigue using a holographic agent includes at least one processor and at least one memory communicatively coupled to the at least one processor. The at least one memory includes instructions that upon execution by the at least one processor, cause the at least one processor to: receive operator alertness data associated with a vehicle operator from an operator monitoring system; generate a first agent action based at least in part on the operator alertness data; transmit a first command to a hologram generation system to generate a holographic agent to implement the first agent action; receive updated operator alertness data from the operator monitoring system following implementation of the first agent action by the holographic agent; generate a second agent action based at least in part on the updated operator alertness data; and transmit a second command to the hologram generation system to generate the holographic agent to implement the second agent action.

In various embodiments, a method of mitigating vehicle operator fatigue using a holographic agent includes: receiving operator alertness data associated with a vehicle operator from an operator monitoring system; generating a first agent action based at least in part on the operator alertness data; transmitting a first command to a hologram generation system to generate a holographic agent to implement the first agent action; receiving updated operator alertness data from the operator monitoring system following implementation of the first agent action by the holographic agent; generating a second agent action based at least in part on the updated operator alertness data; and transmitting a second command to the hologram generation system to generate the holographic agent to implement the second agent action.

Furthermore, other desirable features and characteristics of the systems and methods for mitigating vehicle operator fatigue using a holographic agent become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a block diagram representation of a system configured implement mitigation of vehicle operator fatigue using a holographic agent in accordance with least one embodiment;

FIG. 2 is a block diagram representation of an aircraft including a vehicle operator fatigue mitigation system in accordance with at least one embodiment;

FIG. 3 is a flowchart representation of a method of mitigating vehicle operator fatigue using a holographic agent in accordance with at least one embodiment; and

FIG. 4 is an exemplary illustration of a holographic agent in a cockpit of an aircraft in accordance with at least one embodiment.

### DETAILED DESCRIPTION

The following detailed description is merely exemplary in nature. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

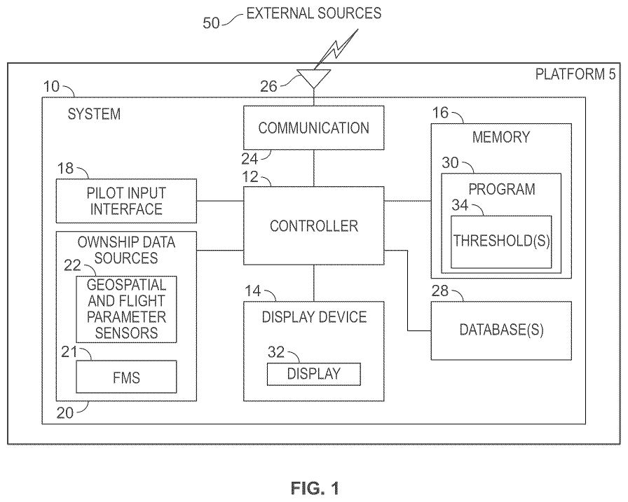

FIG. 1 is a block diagram representation of a system 10 configured implement mitigation of vehicle operator fatigue using a holographic agent in accordance with least one embodiment (shortened herein to “system” 10). The system 10 may be utilized onboard a mobile platform 5, as described herein. In various embodiments, the mobile platform is an aircraft, which carries or is equipped with the system 10. As schematically depicted in FIG. 1, the system 10 includes the following components or subsystems, each of which may assume the form of a single device or multiple interconnected devices: a controller circuit 12 operationally coupled to: at least one display device 14; computer-readable storage media or memory 16; an optional input interface 18, and ownship data sources 20 including, for example, a flight management system (FMS) 21 and an array of flight system state and geospatial sensors 22.

In various embodiments, the system 10 may be separate from or integrated within: the flight management system (FMS) 21 and/or a flight control system (FCS). Although schematically illustrated in FIG. 1 as a single unit, the individual elements and components of the system 10 can be implemented in a distributed manner utilizing any practical number of physically distinct and operatively interconnected pieces of hardware or equipment. When the system 10 is utilized as described herein, the various components of the system 10 will typically all be located onboard the mobile platform 5.

The term “controller circuit” (and its simplification, “controller”), broadly encompasses those components utilized to carry-out or otherwise support the processing functionalities of the system 10. Accordingly, the controller circuit 12 can encompass or may be associated with a programmable logic array, application specific integrated circuit or other similar firmware, as well as any number of individual processors, flight control computers, navigational equipment pieces, computer-readable memories (including or in addition to the memory 16), power supplies, storage devices, interface cards, and other standardized components. In various embodiments, the controller circuit 12 embodies one or more processors operationally coupled to data storage having stored therein at least one firmware or software program (generally, computer-readable instructions that embody an algorithm) for carrying-out the various process tasks, calculations, and control/display functions described herein. During operation, the controller circuit 12 may be programmed with and execute the at least one firmware or software program, for example, a program 30, that embodies an algorithm described herein for mitigating vehicle operator fatigue using a holographic agent in accordance with least one embodiment on a mobile platform 5, where the mobile platform 5 is an aircraft, and to accordingly perform the various process steps, tasks, calculations, and control/display functions described herein.

The controller circuit 12 may exchange data, including real-time wireless data, with one or more external sources 50 to support operation of the system 10 in embodiments. In this case, bidirectional wireless data exchange may occur over a communications network, such as a public or private network implemented in accordance with Transmission Control Protocol/Internet Protocol architectures or other conventional protocol standards. Encryption and mutual authentication techniques may be applied, as appropriate, to ensure data security.

The memory 16 is a data storage that can encompass any number and type of storage media suitable for storing computer-readable code or instructions, such as the aforementioned software program 30, as well as other data generally supporting the operation of the system 10. The memory 16 may also store one or more threshold 34 values, for use by an algorithm embodied in software program 30. One or more database(s) 28 are another form of storage media; they may be integrated with memory 16 or separate from it.

In various embodiments, aircraft-specific parameters and information for an aircraft may be stored in the memory 16 or in a database 28 and referenced by the program 30. Non-limiting examples of aircraft-specific information includes an aircraft weight and dimensions, performance capabilities, configuration options, and the like.

Flight parameter sensors and geospatial sensors 22 supply various types of data or measurements to the controller circuit 12 during an aircraft flight. In various embodiments, the geospatial sensors 22 supply, without limitation, one or more of: inertial reference system measurements providing a location, Flight Path Angle (FPA) measurements, airspeed data, groundspeed data (including groundspeed direction), vertical speed data, vertical acceleration data, altitude data, attitude data including pitch data and roll measurements, yaw data, heading information, sensed atmospheric conditions data (including wind speed and direction data), flight path data, flight track data, radar altitude data, and geometric altitude data.

With continued reference to FIG. 1, the display device 14 can include any number and type of image generating devices on which one or more avionic displays 32 may be produced. When the system 10 is utilized for a manned aircraft, the display device 14 may be affixed to the static structure of the Aircraft cockpit as, for example, a Head Down Display (HDD) or Head Up Display (HUD) unit. In various embodiments, the display device 14 may assume the form of a movable display device (e.g., a pilot-worn display device) or a portable display device, such as an Electronic Flight Bag (EFB), a laptop, or a tablet computer carried into the aircraft cockpit by a pilot.

At least one avionic display 32 is generated on the display device 14 during operation of the system 10; the term “avionic display” is synonymous with the term “aircraft-related display” and “cockpit display” and encompasses displays generated in textual, graphical, cartographical, and other formats. The system 10 can generate various types of lateral and vertical avionic displays 32 on which map views and symbology, text annunciations, and other graphics pertaining to flight planning are presented for a pilot to view. The display device 14 is configured to continuously render at least a lateral display showing the aircraft at its current location within the map data. The avionic display 32 generated and controlled by the system 10 can include graphical user interface (GUI) objects and alphanumerical input displays of the type commonly presented on the screens of multifunction control display units (MCDUs), as well as Control Display Units (CDUs) generally. Specifically, embodiments of the avionic displays 32 include one or more two-dimensional (2D) avionic displays, such as a horizontal (i.e., lateral) navigation display or vertical navigation display (i.e., vertical situation display VSD); and/or on one or more three dimensional (3D) avionic displays, such as a Primary Flight Display (PFD) or an exocentric 3D avionic display.

In various embodiments, a human-machine interface is implemented as an integration of a pilot input interface 18 and a display device 14. In various embodiments, the display device 14 is a touch screen display. In various embodiments, the human-machine interface also includes a separate pilot input interface 18 (such as a keyboard, cursor control device, voice input device, or the like), generally operationally coupled to the display device 14. Via various display and graphics systems processes, the controller circuit 12 may command and control a touch screen display device 14 to generate a variety of graphical user interface (GUI) objects or elements described herein, including, for example, buttons, sliders, and the like, which are used to prompt a user to interact with the human-machine interface to provide user input; and for the controller circuit 12 to activate respective functions and provide user feedback, responsive to received user input at the GUI element. In at least one embodiment, a human-machine interface is implemented via a holographic agent generated by a hologram generation system.

In various embodiments, the system 10 may also include a dedicated communications circuit 24 configured to provide a real-time bidirectional wired and/or wireless data exchange for the controller 12 to communicate with the external sources 50 (including, each of: traffic, air traffic control (ATC), satellite weather sources, ground stations, and the like). In various embodiments, the communications circuit 24 may include a public or private network implemented in accordance with Transmission Control Protocol/Internet Protocol architectures and/or other conventional protocol standards. Encryption and mutual authentication techniques may be applied, as appropriate, to ensure data security. In some embodiments, the communications circuit 24 is integrated within the controller circuit 12, and in other embodiments, the communications circuit 24 is external to the controller circuit 12. When the external source 50 is “traffic,” the communications circuit 24 may incorporate software and/or hardware for communication protocols as needed for traffic collision avoidance (TCAS), automatic dependent surveillance-broadcast (ADS-B), and enhanced vision systems (EVS).

In certain embodiments of the system 10, the controller circuit 12 and the other components of the system 10 may be integrated within or cooperate with any number and type of systems commonly deployed onboard an aircraft including, for example, an FMS 21.

The disclosed algorithm is embodied in a hardware program or software program (e.g. program 30 in controller circuit 12) and configured to operate when the aircraft is in any phase of flight.

In various embodiments, the provided controller circuit 12, and therefore its program 30 may incorporate the programming instructions for: receiving operator alertness data associated with a vehicle operator from an operator monitoring system; generating a first agent action based at least in part on the operator alertness data; transmitting a first command to a hologram generation system to generate a holographic agent to implement the first agent action; receiving updated operator alertness data from the operator monitoring system following implementation of the first agent action by the holographic agent; generating a second agent action based at least in part on the updated operator alertness data; and transmitting a second command to the hologram generation system to generate the holographic agent to implement the second agent action.

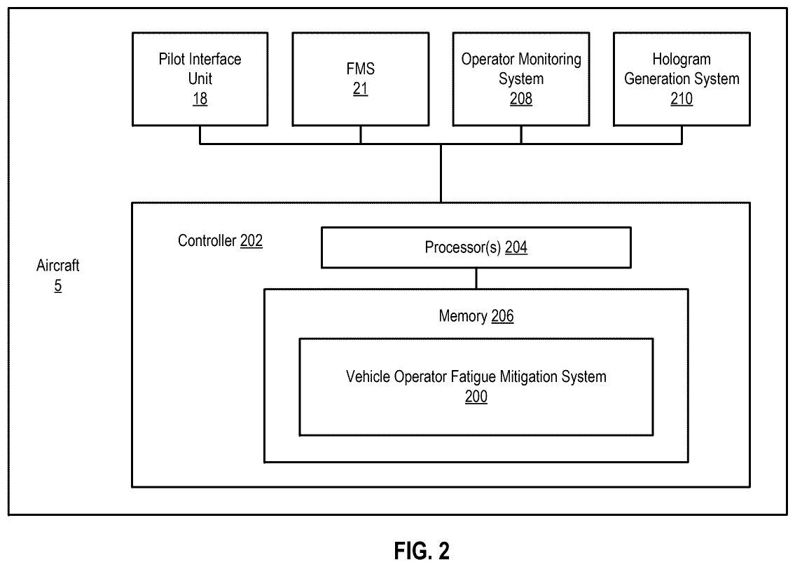

Referring to FIG. 2, a block diagram representation of an aircraft 5 including a vehicle operator fatigue mitigation system 200 in accordance with at least one embodiment is shown. The aircraft 5 includes a controller 202. The controller 202 includes at least one processor 204 and at least one memory 206. The at least one memory 206 includes the vehicle operator fatigue mitigation system 200. In various embodiments, the controller 202 may include additional components that facilitate operation of the controller 202.

The controller 202 is configured to be communicatively coupled to a pilot interface unit 18, a flight management system (FMS) 21, an operator monitoring system 208, and a hologram generation system 210. The pilot interface unit 18 is similar to the pilot interface unit 18 described with reference to FIG. 1. The FMS 21 is similar to the FMS 21 described with reference to FIG. 1. The operator monitoring system 208 is configured to receive operator alertness data. Examples of operator alertness data include, but are not limited to, operator biometric data, operator image data, and operator audio data.

In at least one embodiment, the hologram generation system is an augmented reality (AR) system. In at least one embodiment, the hologram generation system 210 is a mixed reality (MR) system. In at least one embodiment, the hologram generation system 210 is a reflection hologram system. In at least one embodiment, the hologram generation system 210 is a transmission hologram system. In at least one embodiment, the hologram generation system 210 is a hybrid hologram system. The operation of the vehicle operator fatigue mitigation system 200 will be described in greater detail below.

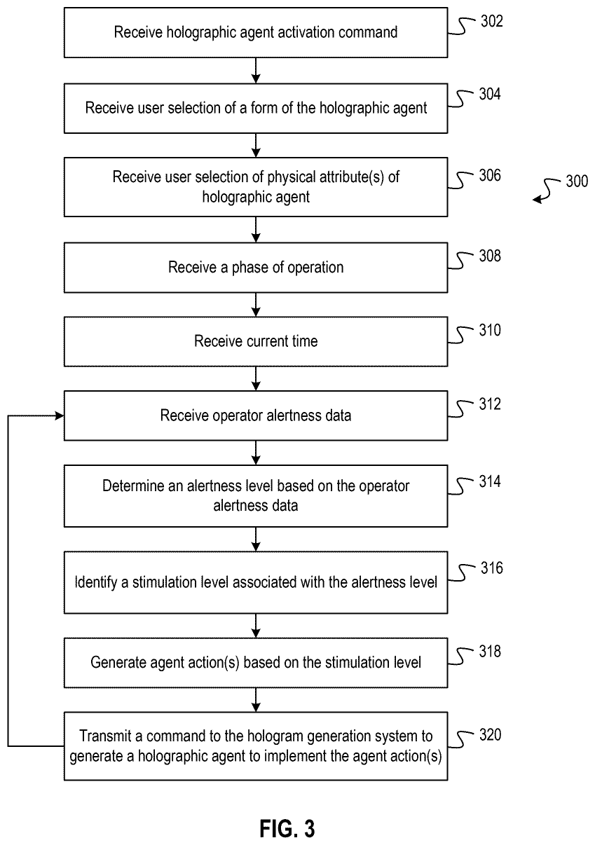

Referring to FIG. 3, a flowchart representation of a method 300 of mitigating vehicle operator fatigue using a holographic agent in accordance with at least one embodiment is shown. The method 300 will be described with reference to an exemplary implementation of a vehicle operator fatigue mitigation system 200. As can be appreciated in light of the disclosure, the order of operation within the method 300 is not limited to the sequential execution as illustrated in FIG. 3 but may be performed in one or more varying orders as applicable and in accordance with the present disclosure.

At 302, the vehicle operator fatigue mitigation system 200 receives a holographic agent activation command. In at least one embodiment, the vehicle operator fatigue mitigation system 200 receives the holographic agent activation command from a pilot via a pilot interface unit 18 of an aircraft 5.

At 304, the vehicle operator fatigue mitigation system 200 receives a user selection of a form of the holographic agent. In at least one embodiment, the vehicle operator fatigue mitigation system 200 receives the user selection of the form of the holographic agent via the pilot interface unit 18 of the aircraft 5. In at least one embodiment, the user is provided with an option to select an anthropomorphic holographic agent as the form of the holographic agent. In at least one embodiment, a default form of the holographic agent is the anthropomorphic holographic agent. In at least one embodiment, the anthropomorphic holographic agent is an anthropomorphic co-vehicle operator holographic agent. In at least one embodiment, the anthropomorphic holographic agent is an anthropomorphic co-pilot holographic agent.

In at least one embodiment, the user is provided with an option to select a human head holographic agent as the form of the holographic agent. In at least one embodiment, the user is provided with the option to select an animal holographic agent as the form of the holographic agent.

At 306, the vehicle operator fatigue mitigation system 200 receives user selection of at least one of attribute of the holographic agent. In at least one embodiment, the vehicle operator fatigue mitigation system 200 receives the user selections of the attribute(s) of the holographic agent via the pilot interface unit 18. Examples of attributes include, but are not limited to, a gender of the holographic agent and a language spoken by the holographic agent. When the user selected form of the holographic agent is the animal holographic agent, examples of attributes include, but are not limited to, a dog, a cat, and a bird.

At 308, the vehicle operator fatigue mitigation system 200 receives a phase of operation from the FMS 21 of the aircraft 5. Examples of phases of operation include, but are not limited to, a take-off phase of flight, a climbing phase of flight, a cruising phase of flight, a descent phase of fight, an approach phase of flight, landing phase of flight, and a taxiing phase of flight.

At 310, the vehicle operator fatigue mitigation system 200 receives a current time. In at least one embodiment, the vehicle operator fatigue mitigation system 200 receives the current time from a clock of the aircraft 5. In at least one embodiment, the vehicle operator fatigue mitigation system 200 receives the current time from the FMS 21.

At 312, the vehicle operator fatigue mitigation system 200 receives operator alertness data associated with the vehicle operator from an operator monitoring system 208. In at least one embodiment, the vehicle operator is a pilot of the aircraft 5. In at least one embodiment, the operator alertness data is operator biometric data. The operator, such as for example the pilot, wears a wearable biometric measurement device. The wearable biometric measurement device transmits measured operator biometric data to the operator monitoring system 208. Examples of operator biometric data include, but are not limited to, operator heart rate and operator respiration rate.

In at least one embodiment, the operator alertness data is operator image data. One or more cameras onboard the aircraft 5 transmit images of the operator, such as for example the pilot, to the operator monitoring system 208. The vehicle operator fatigue mitigation system 200 receives the images of the operator from the operator monitoring system 208. The vehicle operator fatigue mitigation system 200 extracts operator image data from the images of the operator. Examples of operator image data includes, but is not limited to, a posture of the operator and eye movement of the operator. The operator image data includes responses by the operator to agent actions implemented by a holographic agent.

In at least one embodiment, the operator alertness data is operator audio data. One or more microphones onboard the aircraft 5 transmit operator audio data to the operator monitoring system 208. The vehicle operator fatigue mitigation system 200 receives the operator audio data from the operator monitoring system 208. Examples of operator audio data include, but are not limited to, audio responses by the operator to agent actions implemented by a holographic agent. In at least one embodiment, the operator alertness data is a combination of at least two of the operator biometric data, the operator image data, and the operator audio data. In at least one embodiment, the vehicle operator fatigue mitigation system 200 is configured to determine one or more agent actions for implementation by the holographic agent based at least in part on the operator alertness data.

At 314, the vehicle operator fatigue mitigation system 200 determines an alertness level of the vehicle operator based on the operator alertness data. In at least one embodiment, the alertness level is one of a plurality of different alertness levels. In various embodiments, the different alertness levels include, but are not limited to, a normal alertness level, a low alertness level, and a very low alertness level. In at least one embodiment, different operator biometric data correspond to different alertness levels. In at least one embodiment, different operator image data correspond to different alertness levels. In at least one embodiment, different operator audio data correspond to different alertness levels. In at least one embodiment, combinations of the different operator biometric data, the different operator image data, and the different operator audio data correspond to different alertness levels. For example, a low heart rate combined with a low level of eye movement may indicate a low alertness level of the vehicle operator. In at least one embodiment, the vehicle operator fatigue mitigation system 200 is configured to determine one or more agent actions for implementation by the holographic agent based at least in part on the alertness level of the vehicle operator.

At 316, the vehicle operator fatigue mitigation system 200 identifies a stimulation level associated with the alertness level of the operator. In at least one embodiment each of the different alertness levels is associated with a specific stimulation level. In various embodiments, the normal alertness level is associated with a low stimulation level, the low alertness level is associated with an elevated stimulation level, and the very low alertness level is associated with a high stimulation level.

At 318, the vehicle operator fatigue mitigation system 200 generates one or more agent actions for implementation by the holographic agent based on the identified stimulation level. Examples of agent actions include, but are not limited to a gesture, a vocalization, and an expression.

For example, if the vehicle operator fatigue mitigation system 200 identifies a low stimulation level associated with a normal alertness level of the operator, the vehicle operator fatigue mitigation system 200 may generate agent actions for the holographic agent to interact with the operator using a conversational voice tone and a relaxed expression.

If the vehicle operator fatigue mitigation system 200 identifies an elevated stimulation level associated with a low alertness level of the operator, the vehicle operator fatigue mitigation system 200 may generate agent actions for the holographic agent to ask the operator general questions in an attempt to elicit a response from the operator to increase the alertness level of the operator.

If the vehicle operator fatigue mitigation system 200 identifies high stimulation level associated with a very low alertness level of the operator, the vehicle operator fatigue mitigation system 200 may generate agent actions for the holographic agent to use a louder voice tone, ask the operator vehicle operation related questions, ask the operator questions regarding their alertness level, and show a concerned expression.

In at least one embodiment, the vehicle operator fatigue mitigation system 200 is configured to modify the agent action based on the phase of operation of the aircraft. For example, if the alertness level of the operator is low and the phase of operation of the aircraft is a landing phase of flight, the vehicle operator fatigue mitigation system 200 may modify the agent action to ask the operator vehicle operation related questions associated with landing the aircraft 5 in an attempt to ensure that the operator does not miss implementation of a vehicle operation associated with landing the aircraft 5.

In at least one embodiment, the vehicle operator fatigue mitigation system 200 is configured to modify the agent action base on the current time. For example, if the alertness level of the operator is low and the current time is 2 AM the vehicle operator fatigue mitigation system 200 may modify the agent actions from an elevated stimulation level to a high stimulation level.

At 320, the vehicle operator fatigue mitigation system 200 transmits a command to the hologram generation system 210 to generate a holographic agent to implement the agent action(s). In at least one embodiment, the command includes the user selected form of the holographic agent, the user selected attribute(s) of the holographic agent, and instructions to implement the agent action(s). The hologram generation system 210 generates the holographic agent in the user selected form including the user selected attributes. The hologram generation system 210 generates the holographic agent to implement the agent actions.

The method 300 returns to 312. The vehicle operator fatigue mitigation system 200 receives updated operator alertness data. The vehicle operator fatigue mitigation system 200 uses the updated operator alertness data to determine an updated alertness level of the operator. The vehicle operator fatigue mitigation system 200 identifies an updated stimulation level based on the updated alertness level. The vehicle operator fatigue mitigation system 200 generates updated agent action(s) and transmits a command to the hologram generation system 210 to generate the holographic agent to implement the updated agent action(s).

While the vehicle operator fatigue mitigation system 200 in the method 300 has been described with reference to an aircraft vehicle operator, the vehicle operator fatigue mitigation system 200 can be used to implement the method 300 for a ground vehicle operator, an underwater vehicle operator, and a water surface vehicle operator.

In at least one embodiment, a vehicle operator is provided with an option of issuing an operator request for a holographic agent to engage in one or more fatigue mitigation actions via the pilot user interface 18. The vehicle operator fatigue mitigation system 200 is configured to receive an operator request for a holographic agent to engage in one or more fatigue mitigation actions. The vehicle operator fatigue mitigation system 200 is configured to transmit a command to the hologram generation system 210 to generate the holographic agent to implement one or more fatigue mitigation actions. An example of a fatigue mitigation action is engaging in a conversation with the vehicle operator.

In at least one embodiment, the vehicle operator fatigue mitigation system 200 is configured to generate a holographic environment associated with the holographic agent. The vehicle operator fatigue mitigation system 200 is configured to transmit a command to the hologram generation system 210 to generate the holographic environment in association with the holographic agent. For example, a holographic environment associated with a holographic agent having a form of a co-pilot may include a holographic seat for the co-pilot.

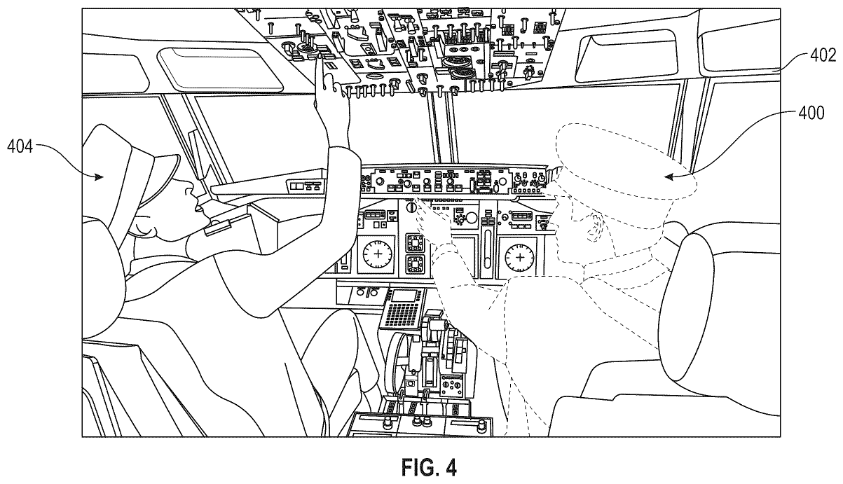

Referring to FIG. 4, an exemplary illustration of a holographic agent 400 in a cockpit 402 of an aircraft 5 in accordance with at least one embodiment is shown. The vehicle operator is a pilot 404 of the aircraft 5. The pilot 404 selected an anthropomorphic holographic agent as the form of the holographic agent 400. The anthropomorphic holographic agent is an anthropomorphic co-vehicle operator holographic agent. The pilot selected a male gender as an attribute of the holographic agent 400. The vehicle operator fatigue mitigation system 200 received the pilot selections of the form and the attribute of the holographic agent 400. The vehicle operator fatigue mitigation system 200 received operator alertness data associated with the pilot 404, determined an alertness level of the pilot 404 based on the operator alertness data, and identified a stimulation level associated with the determined alertness level. The vehicle operator fatigue mitigation system 200 generated agent actions based on the stimulation level. The vehicle operator fatigue mitigation system 200 issued a command to a hologram generation system 210 to generate the holographic agent 400 in the form of a male anthropomorphic holographic agent to implement the agent actions. For example, the anthropomorphic co-vehicle operator holographic agent is implementing agent actions in the form of gestures associated with the operation of the aircraft 5.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for mitigating vehicle operator fatigue using a holographic agent comprising:
at least one processor; and
at least one memory communicatively coupled to the at least one processor, the at least one memory comprising instructions that upon execution by the at least one processor, cause the at least one processor to:
receive operator alertness data associated with a vehicle operator from an operator monitoring system;
generate a first agent action based at least in part on the operator alertness data;
transmit a first command to a hologram generation system to generate a holographic agent to implement the first agent action;
receive updated operator alertness data from the operator monitoring system following implementation of the first agent action by the holographic agent;
generate a second agent action based at least in part on the updated operator alertness data; and
transmit a second command to the hologram generation system to generate the holographic agent to implement the second agent action.

2. The system of claim 1, wherein the at least one memory comprising instructions that upon execution by the at least one processor, cause the at least one processor to:
determine a first alertness level of the vehicle operator based on the operator alertness data; and
determine the first agent action based at least in part on the first alertness level.

3. The system of claim 2, wherein the at least one memory comprising instructions that upon execution by the at least one processor, cause the at least one processor to:
determine a second alertness level of the vehicle operator based on the updated operator alertness data; and
determine the second agent action based at least in part on the second alertness level.

4. The system of claim 2, wherein the at least one memory comprising instructions that upon execution by the at least one processor, cause the at least one processor to:
identify a first stimulation level associated with the first alertness level; and
generate the first agent action based at least in part on the first stimulation level.

5. The system of claim 4, wherein the at least one memory comprising instructions that upon execution by the at least one processor, cause the at least one processor to:
receive a phase of operation of the vehicle; and
modify the first agent action based at least in part on the phase of operation of the vehicle.

6. The system of claim 4, wherein the at least one memory comprising instructions that upon execution by the at least one processor, cause the at least one processor to:
receive a current time; and
modify the first agent action based at least in part on the current time.

7. The system of claim 1, wherein the at least one memory comprising instructions that upon execution by the at least one processor, cause the at least one processor to:
receive a user selection of a form of the holographic agent; and
transmit the first command to the hologram generation system to generate the holographic agent in accordance with the selected form.

8. The system of claim 1, wherein the at least one memory comprising instructions that upon execution by the at least one processor, cause the at least one processor to:
receive a user selection of at least one attribute of the holographic agent; and
transmit the first command to the hologram generation system to generate the holographic agent in accordance with the at least one attribute.

9. The system of claim 1, wherein the at least one memory comprising instructions that upon execution by the at least one processor, cause the at least one processor to transmit the first command to the hologram generation system to generate the holographic agent as an anthropomorphic holographic agent.

10. The system of claim 1, wherein the at least one memory comprising instructions that upon execution by the at least one processor, cause the at least one processor to transmit the first command to the hologram generation system to generate a holographic agent as an anthropomorphic co-pilot holographic agent.

11. The system of claim 1, wherein the at least one memory comprising instructions that upon execution by the at least one processor, cause the at least one processor to transmit the first command to the hologram generation system to generate the holographic agent to implement the first agent action, the first agent action comprising at least one of a gesture, a vocalization, and an expression.

12. The system of claim 1, wherein the at least one memory comprising instructions that upon execution by the at least one processor, cause the at least one processor to transmit the command to the hologram generation system to generate the holographic agent, the hologram generation system being at least one of an augmented reality (AR) system, a mixed reality (MR) system, a reflection hologram system, a transmission hologram system, and a hybrid hologram system.

13. The system of claim 1, wherein the at least one memory comprising instructions that upon execution by the at least one processor, cause the at least one processor to receive the operator alertness data associated with the vehicle operator, the vehicle operator alertness data being associated with at least one of an aircraft vehicle operator, a ground vehicle operator, an underwater vehicle operator, and a water surface vehicle operator.

14. The system of claim 1, wherein the at least one memory comprising instructions that upon execution by the at least one processor, cause the at least one processor to:
receive an operator request for the holographic agent to engage in at least one fatigue mitigation action; and
transmit a third command to the hologram generation system to generate the holographic agent to implement the at least one fatigue mitigation action.

15. The system of claim 1, wherein the at least one memory comprising instructions that upon execution by the at least one processor, cause the at least one processor to receive the operator alertness data associated with the vehicle operator, the operator alertness data comprising at least one of operator biometric data, operator image data, and operator audio data.

16. The system of claim 1, wherein the at least one memory comprising instructions that upon execution by the at least one processor, cause the at least one processor to:
generate a holographic environment associated with the holographic agent; and
transmit a fourth command to the hologram generation system to generate the holographic environment in association with the holographic agent.

17. A method of mitigating vehicle operator fatigue using a holographic agent comprising:
receiving operator alertness data associated with a vehicle operator from an operator monitoring system;
generating a first agent action based at least in part on the operator alertness data;
transmitting a first command to a hologram generation system to generate a holographic agent to implement the first agent action;
receiving updated operator alertness data from the operator monitoring system following implementation of the first agent action by the holographic agent;
generating a second agent action based at least in part on the updated operator alertness data; and
transmitting a second command to the hologram generation system to generate the holographic agent to implement the second agent action.

18. The method of claim 17, further comprising:
determining a first alertness level of the vehicle operator based on the operator alertness data; and
determining the first agent action based at least in part on the first alertness level.

19. The method of claim 18, further comprising:
determining a second alertness level of the vehicle operator based on the updated operator alertness data; and
determining the second agent action based at least in part on the second alertness level.

20. The method of claim 18, further comprising:
determining whether the first alertness level is lower than a first alertness threshold; and
generating a first characteristic of the first agent action based at least in part on the determination, the first characteristic being associated with a first stimulation level.
